(19) United States
(12) Patent Application Publication
(10) Pub. No.: US 2009/0231214 A1
(43) Pub. Date: Sep. 17, 2009

(54) ANTENNA UNIT AND COMMUNICATION DEVICE

(76) Inventor: Atsushi Mukouyama, Tokyo (JP)

Correspondence Address: NEC CORPORATION OF AMERICA, 6535 N. STATE HWY 161, IRVING, TX, 75039, US

(21) Appl. No.: 12/090,132

(22) PCT Filed: Oct. 11, 2006
(86) PCT No.: PCT/JP2006/320313

§ 371 Date: Apr. 25, 2008

(30) Foreign Application Priority Data
Oct. 17, 2005 (JP) 2005-301808

(51) Int. Cl. H01Q 1/36; H01Q 1/24

(52) U.S. Cl. 343/702; 343/700 MS; 343/893

(57) ABSTRACT

The present invention is to provide an antenna unit for suppressing deterioration of antenna characteristics when a plurality of antenna conductive elements are disposed in a housing. The antenna unit comprises a plurality of antenna conductive elements (4, 5) with different resonant frequencies disposed in a housing (2), wherein the plurality of antenna conductive elements (4, 5) comprise at least a first antenna conductive element (4) and a second antenna conductive element (5) that resonates at a lower frequency than the first antenna conductive element (4), and the second antenna conductive element (5) is disposed farther from a shell of the housing (2) than the first antenna conductive element (4).

### TECHNICAL FIELD

The present invention relates to an antenna unit comprising a plurality of antenna conductive elements disposed in a housing and a communication device mounting the antenna unit.

### BACKGROUND ART

Recently, communication devices such as cell phones have been more and more reduced in size, weight and thickness. However, with the reduction in size, weight and thickness of communication devices, there have been stricter restrictions on disposing an antenna conductive element in a communication device. As a result, antenna conductive elements are easily affected by external environment such as fingers and metals, which causes deterioration of antenna electrical characteristics.

In addition, with an increase in the capacity of communication lines, multiband adaptive communication devices have become popular. In a case of the multiband adaptive communication devices, a plurality of antenna conductive elements are disposed in a housing. It is a problem how to dispose a plurality of antenna conductive elements in a limited area of a housing without deteriorating the antenna characteristics and it is also the core of designing antennas.

Among related art documents filed before the present invention, there is a document disclosing a portable wireless device including a dielectric laminated chip antenna in a housing as a built-in antenna, comprising: a flexible printed circuit on which a wiring pattern is formed and the dielectric laminated chip antenna is fixed so as to be connected to the wiring pattern; a feeding metal spring; and a resin circuit board on which major electric parts such as a CPU are mounted to comprise various circuits such as a wireless circuit and a feeding land connected to the wireless circuit is formed, wherein the flexible printed circuit is fixed to an inner wall of a rear case in the housing and the wiring pattern of the flexible printed circuit and the feeding land are connected by the feeding metal spring, so as to keep the dielectric laminated chip antenna apart from the front case to suppress deterioration of antenna radiation characteristics (see, for example, Patent Document 1).

Also, there is a document disclosing a portable terminal device comprising a portable-terminal-device housing for housing a wireless transceiver circuit, and a helical antenna attached to the upper end portion of the portable-terminal-device housing, connected to the wireless transceiver circuit and transmitting and receiving wireless signals in cooperation with the wireless transceiver circuit, wherein the helical antenna comprises an antenna element including a helical portion in the base end side and a straight portion in the distal end side, the straight portion being located on the extension of a helical axis line of the helical portion, a cap for housing the antenna element in its inside by covering the antenna element from the distal end side, and an element position holding portion disposed inside the cap and holding the straight portion of the antenna element on the extension of the helical axis line of the helical portion, so as to stably keep a distance between the antenna element and a human body to achieve good antenna characteristics all the time (see, for example, Patent Document 2).

In addition, there is a document disclosing an antenna structure to be provided for a portable wireless communication device, comprising an antenna portion protruding from a housing of the portable wireless communication device, and a cap covering the surface of the antenna portion, wherein the outer surface of the cap and the surface of the antenna portion are distantly positioned, to prevent deterioration of antenna gain of the antenna portion (see, for example, Patent Document 3).

### Patent Document 1: Japanese Patent Laid-Open No. 2000-196487

### Patent Document 2: Japanese Patent Laid-Open No. 2003-37417

### Patent Document 3: Japanese Patent Laid-Open No. 2003-69327

### DISCLOSURE OF THE INVENTION

### Problem to be Solved by the Invention

Although techniques for suppressing deterioration of antenna characteristics are disclosed in the Patent Documents 1 to 3, the case of suppressing deterioration of antenna characteristics when a plurality of antenna conductive elements are disposed in a housing is not considered at all in the Patent Documents 1 to 3.

The present invention has been made in view of such circumstances, an object of the present invention is to provide an antenna unit and a communication device for suppressing deterioration of antenna characteristics when a plurality of antenna conductive elements are disposed in a housing.

### Means for Solving the Problem

In order to achieve such an object, the present invention has the following features.

An antenna unit according to the present invention is an antenna unit comprising a plurality of antenna conductive elements with different resonant frequencies disposed in a housing, wherein the plurality of antenna conductive elements comprise at least a first antenna conductive element and a second antenna conductive element that resonates at a lower frequency than the first antenna conductive element, and the second antenna conductive element is disposed farther from a shell of the housing than the first antenna conductive element.

In addition, another antenna unit according to the present invention is an antenna unit comprising a plurality of antenna conductive elements disposed in a housing, wherein the plurality of antenna conductive elements comprise at least a first antenna conductive element and a second antenna conductive element that is longer than the first antenna conductive element, and the second antenna conductive element is disposed farther from a shell of the housing than the first antenna conductive element.

In the antenna unit according to the present invention, the second antenna conductive element may be disposed in the center of the housing.

In the antenna unit according to the present invention, the second antenna conductive element may resonate at the lowest frequency in the plurality of antenna conductive elements.

In the antenna unit according to the present invention, the second antenna conductive element may be longest in the plurality of antenna conductive elements.

In the antenna unit according to the present invention, the plurality of antenna conductive elements may be laminatedly disposed in the housing.

A communication device according to the present invention comprises the above antenna unit mounted thereon.

### EFFECTS OF THE INVENTION

The present invention is characterized in that an antenna unit comprises a plurality of antenna conductive elements with different resonant frequencies disposed in a housing, wherein the plurality of antenna conductive elements comprise at least a first antenna conductive element and a second antenna conductive element that resonates at a lower frequency than the first antenna conductive element, and the second antenna conductive element is disposed farther from a shell of the housing than the first antenna conductive element. The present invention also characterized in that an antenna unit comprises a plurality of antenna conductive elements disposed in a housing, wherein the plurality of antenna conductive elements comprise at least a first antenna conductive element and a second antenna conductive element that is longer than the first antenna conductive element, and the second antenna conductive element is disposed farther from the shell of the housing than the first antenna conductive element. As described above, by disposing the second antenna conductive element, which is easily affected by external environment, far from the shell of the housing, it is possible to suppress deterioration of antenna characteristics when the plurality of antenna conductive elements are disposed in the housing.

### BEST MODE FOR CARRYING OUT THE INVENTION

First, with reference to FIG. 1, the characteristics of an antenna unit in the present embodiment will be described.

The antenna unit in the present embodiment is an antenna unit comprising a plurality of antenna conductive elements (4, 5) with different resonant frequencies disposed in a housing (2), wherein the plurality of antenna conductive elements (4, 5) comprise at least a first antenna conductive element (4) and a second antenna conductive element (5) that resonates at a lower frequency than the first antenna conductive element (4), and the second antenna conductive element (5) is disposed farther from a shell of the housing (2) than the first antenna conductive element (4). Alternatively, the antenna unit in the present embodiment is an antenna unit comprising a plurality of antenna conductive elements (4, 5) disposed in a housing (2), wherein the plurality of antenna conductive elements (4, 5) comprise at least a first antenna conductive element (4) and a second antenna conductive element (5) that is longer than the first antenna conductive element (4), and the second antenna conductive element (5) is disposed farther from a shell of the housing (2) than the first antenna conductive element (4). As described above, by disposing the second antenna conductive element (5), which is easily affected by external environment, far from the shell of the housing (2), it is possible to suppress deterioration of antenna characteristics when the plurality of antenna conductive elements (4, 5) are disposed in the housing (2). The antenna unit and a communication device mounting the antenna unit in the present embodiment will be described below with reference to the accompanying drawings. Note that a communication device in the present embodiment refers to any communication device on which the antenna unit described above can be mounted.

### First Exemplary Embodiment

First, with reference to FIG. 2, the configuration of the communication device in the present embodiment will be described.

The communication device in the present embodiment comprises an antenna unit (2) and a wireless circuit board (3) in a housing (1) that comprises a shell of the communication device. In the antenna unit (2), a plurality of antenna conductive elements (4, 5) with different resonant frequencies are disposed.

Next, with reference to FIG. 1, the inner structure of the antenna unit (2) shown in FIG. 2 will be described in detail. (a) is a view of the antenna unit (2) shown in FIG. 2, (b) is a top view of the antenna unit (2) shown in (a) as seen from above, (c) is a side view of the antenna unit (2) shown in (a) as seen from the B direction, and (d) is a side view of the antenna unit (2) shown in (a) as seen from the A direction.

The antenna unit (2) in the present embodiment comprises the plurality of antenna conductive elements (4, 5) with different resonant frequencies disposed in a housing of the antenna unit (2) as shown in FIG. 1. The plurality of antenna conductive elements (4, 5) comprise a first antenna conductive element (4) which is not easily affected by external environment such as fingers and metals, and a second antenna conductive element (5) which is affected by external environment more easily than the first antenna conductive element (4). The first antenna conductive element (4) and the second antenna conductive element (5) are connected by a common antenna conductive element (6) which is a common portion thereof, and are disposed in the housing of the antenna unit (2).

In the antenna unit (2) of the present embodiment, the second antenna conductive element (5) which is easily affected by external environment is disposed in the housing of the antenna unit (2) in a position farther from the shell of the housing than the first antenna conductive element (4) which is not easily affected by external environment as shown in FIG. 1.

As described above, in the antenna unit (2) of the present embodiment, by disposing the second antenna conductive element (5) which is easily affected by external environment as far as possible from the shell of the housing of the antenna unit (2) in the housing, the second antenna conductive element (5) which is easily affected by external environment can be disposed in a position where the second antenna conductive element (5) is not easily affected by external environment even when the plurality of antenna conductive elements (4, 5) are disposed in the housing of the antenna unit (2), so as to suppress deterioration of antenna electrical characteristics. It is preferable to dispose the second antenna conductive element (5) which is easily affected by external environment in the center of the housing of the antenna unit (2). Since the second antenna conductive element (5) can be thereby disposed in a position farthest from the shell of the housing of the antenna unit (2), the second antenna conductive element (5) is least affected by external environment, so as to suppress deterioration of antenna electrical characteristics.

In the above described antenna unit (2) as shown in FIG. 1, the second antenna conductive element (5) which is easily affected by external environment is a meander type antenna conductive element, and the first antenna conductive element (4) which is not easily affected by external environment is an inverted L type antenna conductive element. However, the shape of the antenna conductive elements (4, 5) is not limited specifically. Antenna conductive elements of any shape, such as inverted L type, inverted F type, meander type, helical type and plate type, may be disposed in the housing of the antenna unit (2), as long as the second antenna conductive element (5) to be disposed in a position where the second antenna conductive element (5) is not easily affected by external environment is of such shape that the second antenna conductive element (5) is affected by external environment more easily than the first antenna conductive element (4).

In order that the second antenna conductive element (5) to be disposed in a position where the second antenna conductive element (5) is not easily affected by external environment can be affected by external environment more easily than the first antenna conductive element (4), the second antenna conductive element (5) may be an antenna conductive element that resonates at a lower frequency than the first antenna conductive element (4), or the second antenna conductive element (5) may be an antenna conductive element that is longer than the first antenna conductive element (4).

As described above, in the communication device of the present embodiment, the plurality of antenna conductive elements (4, 5) with different resonant frequencies are disposed in the housing of the antenna unit (2), and the second antenna conductive element (5) that resonates at a lower frequency than the first antenna conductive element (4) is disposed farther from the shell of the housing of the antenna unit (2) than the first antenna conductive element (4). With the feature, even when the plurality of antenna conductive elements (4, 5) are disposed in the housing of the antenna unit (2), it is possible to dispose the second antenna conductive element (5) which is easily affected by external environment in a position where the second antenna conductive element (5) is not easily affected by external environment, so as to suppress deterioration of antenna electrical characteristics.

For example, as to an antenna conductive element of W-CDMA 800 MHz band and an antenna conductive element of W-CDMA 2 GHz band, the antenna conductive element of 800 MHz band which has lower resonant frequency is affected by external environment more easily than the antenna conductive element of 2 GHz band which has higher resonant frequency. Therefore, by disposing the antenna conductive element of 800 MHz band which has lower resonant frequency as far as possible from the shell of the housing of the antenna unit (2), the influences of external environment to the antenna conductive element of 800 MHz band are reduced to suppress deterioration of antenna electrical characteristics.

This is because lower frequency of the antenna conductive element results in a narrower frequency bandwidth of the antenna conductive element and thus more serious deterioration in reflection characteristics at a desired frequency band occurs due to influence of certain external environment.

Also, in a communication device in which restrictions on disposing an antenna conductive element are strict, an antenna conductive element does not have enough size for the frequency to be used. As to an antenna conductive element with a lower frequency, the size thereof becomes different from the ideal size of antenna conductive element to be disposed in the housing. Thus, the antenna conductive element with a lower frequency is more easily affected by external environment.

Therefore, in the communication device in the present embodiment, by disposing the plurality of antenna conductive elements (4, 5) in the housing of the antenna unit (2) and disposing the second antenna conductive element (5) that is longer than the first antenna conductive element (4) farther from the shell of the housing of the antenna unit (2) than the first antenna conductive element (4), it is possible to dispose the second antenna conductive element (5) which is easily affected by external environment in a position where the second antenna conductive element (5) is not easily affected by external environment even when the plurality of antenna conductive elements (4, 5) are disposed in the housing of the antenna unit (2), so as to suppress deterioration of antenna electrical characteristics.

### Second Exemplary Embodiment

Next, the second exemplary embodiment will be described.

Although two antenna conductive elements (4, 5) are disposed in the housing of the antenna unit (2) in the communication device in the first exemplary embodiment, the communication device in the second exemplary embodiment is characterized in that three antenna conductive elements (4, 5, 7) are disposed in the housing of the antenna unit (2), and the antenna conductive element (5) which is most easily affected by external environment is disposed in a position where the antenna conductive element (5) is not easily affected by external environment as shown in FIG. 3. With reference to FIG. 3, the antenna unit mounted on the communication device in the second exemplary embodiment will be described below.

First, the configuration of the antenna unit (2) mounted on the communication device in the second exemplary embodiment will be described with reference to FIG. 3. FIG. 3(a) is a view illustrating the structure where the three antenna conductive elements (4, 5, 7) are laminatedly disposed in the housing of the antenna unit (2), and FIG. 3(b) is a view illustrating the structure where the three antenna conductive elements (4, 5, 7) are laterally disposed in the housing of the antenna unit (2).

In the antenna unit (2) of the second exemplary embodiment, the three antenna conductive elements (4, 5, 7) with different resonant frequencies are disposed in the housing of the antenna unit (2) as shown in FIG. 3. The three antenna conductive elements (4, 5, 7) comprise a first antenna conductive element (4) and a third antenna conductive element (7) which are not easily affected by external environment such as fingers and metals, and a second antenna conductive element (5) which is most easily affected by external environment. In addition, the first antenna conductive element (4), the second antenna conductive element (5) and the third antenna conductive element (7) are connected by a common antenna conductive element (6) which is a common portion thereof, and are disposed in the housing of the antenna unit (2).

In addition, in the antenna unit (2) of the second exemplary embodiment, the second antenna conductive element (5) which is most easily affected by external environment is disposed farther from the shell of the housing of the antenna unit (2) than the first antenna conductive element (4) or the third antenna conductive element (7) which are not easily affected by external environment as shown in FIG. 3.

As described above, in the antenna unit of the second exemplary embodiment, the second antenna conductive element (5) which is most easily affected by external environment is disposed as far as possible from the shell of the housing of the antenna unit (2) as shown in FIG. 3. Because of the feature, even when the plurality of antenna conductive elements (4, 5, 7) are disposed in the housing of the antenna unit (2), it is possible to dispose the second antenna conductive element (5) which is most easily affected by external environment in a position where the second antenna conductive element (5) is not easily affected by external environment, so as to suppress deterioration of antenna electrical characteristics. It is preferable to dispose the second antenna conductive element (5) which is most easily affected by external environment in the center of the housing of the antenna unit (2) by disposing the second antenna conductive element (5) between the first antenna unit (4) and the third antenna unit (7). Since the second antenna conductive element (5) can be thereby disposed farthest from the shell of the housing of the antenna unit (2), the second antenna conductive element (5) is least affected by external environment to suppress deterioration of antenna electrical characteristics.

Although the three antenna conductive elements (4, 5, 7) are disposed in the housing of the antenna unit (2) in the second exemplary embodiment as shown in FIG. 3, the number of antenna conductive elements to be disposed in the housing of the antenna unit (2) is not particularly limited. It is possible to dispose three or more antenna conductive elements in the housing of the antenna unit (2), as long as the second antenna conductive element (5) which is most easily affected by external environment is disposed in the housing of the antenna unit (2) in a position as far as possible from the shell of the housing. Also, the way of disposing a plurality of antenna conductive elements in the housing of the antenna unit (2) is not limited to a particular manner, as long as the second antenna conductive element (5) which is most easily affected by external environment can be disposed in the housing of the antenna unit (2) in a position as far as possible from the shell of the housing. As shown in FIG. 3(a), the three antenna conductive elements (4, 5, 7) may be laminatedly disposed in the housing of the antenna unit (2), or as shown in FIG. 3(b), the three antenna conductive elements (4, 5, 7) may be laterally disposed in the housing of the antenna unit (2).

Note that the exemplary embodiments as described above are preferable embodiments of the present invention. The scope of the present invention is not limited to the embodiments as described above and various modifications may be applied to the present invention without departing from the scope of the present invention.

### INDUSTRIAL APPLICABILITY

The antenna unit and communication device according to the present invention may be applied to communication devices such as cell phones.

### BRIEF DESCRIPTION OF THE DRAWINGS

FIG. 1 is a view illustrating the configuration of an antenna unit in a first exemplary embodiment mounted on a communication device; (a) is a view of the configuration of the antenna unit mounted on the communication device shown in FIG. 2; (b) is a top view of the antenna unit (2) shown in (a) as seen from above; (c) is a side view of the antenna unit (2) shown in (a) as seen from the B direction; and (d) is a side view of the antenna unit (2) shown in (a) as seen from the A direction;

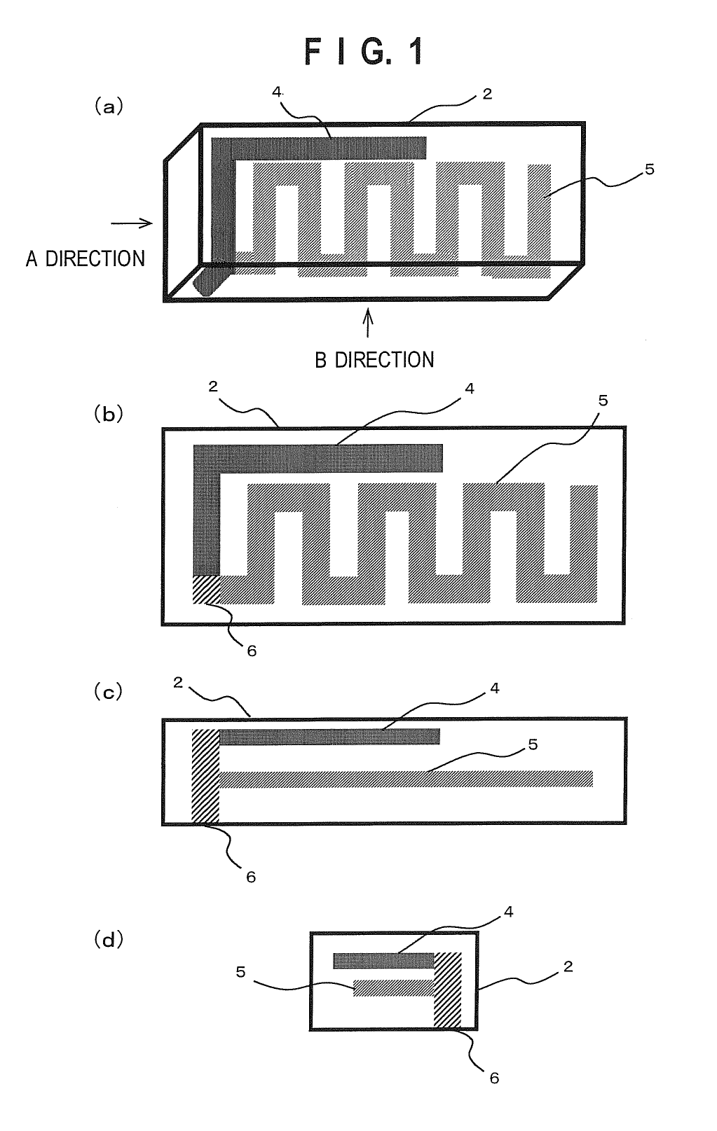

FIG. 2 is a view illustrating the configuration of the communication device mounting the antenna unit in the present embodiment; and

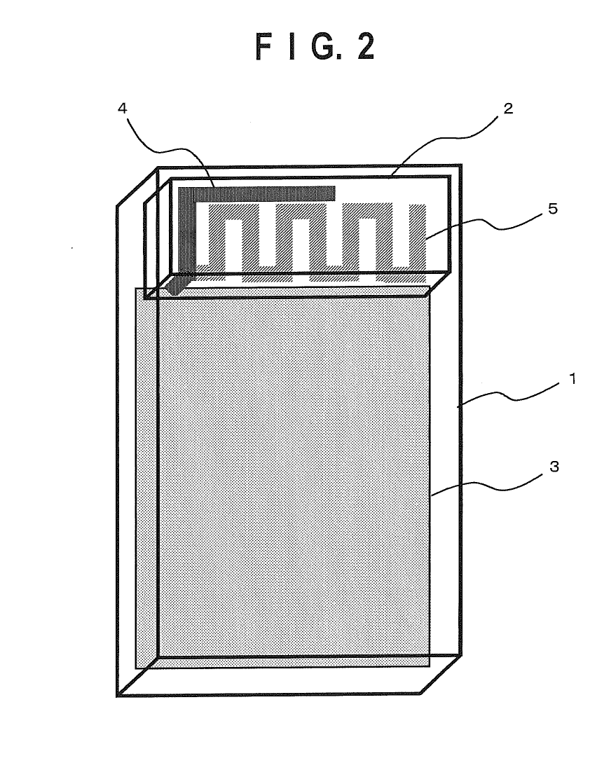

FIG. 3 is a view illustrating the configuration of an antenna unit in a second exemplary embodiment; (a) is a view illustrating the structure where three antenna conductive elements (4, 5, 7) are laminatedly disposed in a housing of the antenna unit (2); and (b) is a view illustrating the structure where three antenna conductive elements (4, 5, 7) are laterally disposed in the housing of the antenna unit (2).

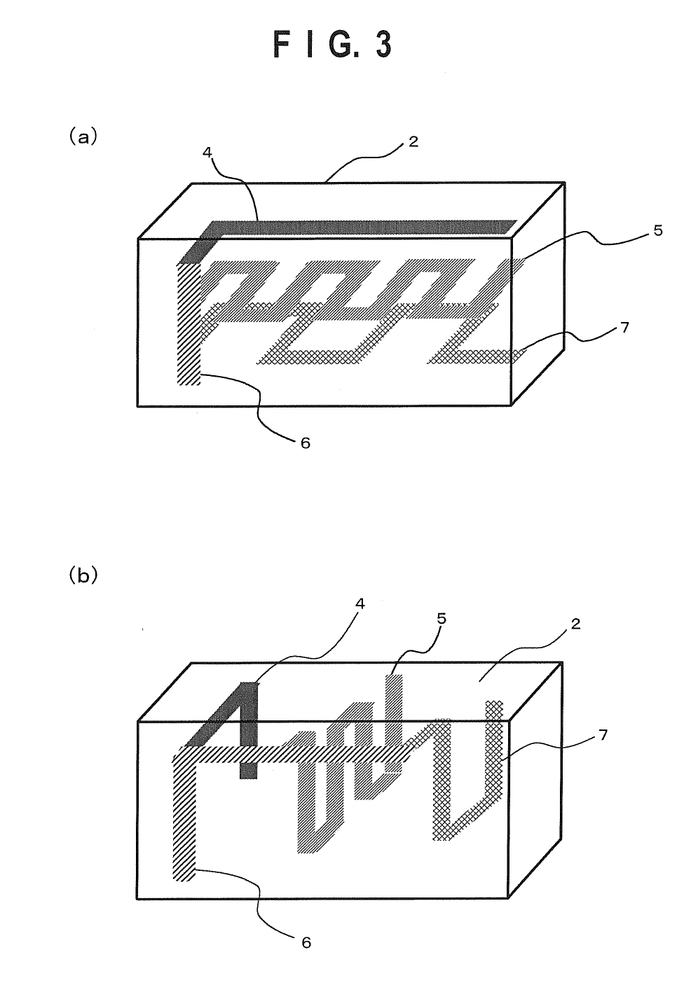

### DESCRIPTION OF SYMBOLS

1: Housing
2: Antenna unit
3: Wireless circuit board
4: Antenna conductive element which is not easily affected by external environment
5: Antenna conductive element which is easily affected by external environment
6: Common antenna conductive element
7: Antenna conductive element which is not easily affected by external environment

1. An antenna unit comprising a plurality of antenna conductive elements with different resonant frequencies disposed in a housing, wherein
the plurality of antenna conductive elements comprise at least a first antenna conductive element and a second antenna conductive element that resonates at a lower frequency than the first antenna conductive element, and
the second antenna conductive element is disposed farther from a shell of the housing than the first antenna conductive element.

2. An antenna unit comprising a plurality of antenna conductive elements disposed in a housing, wherein
the plurality of antenna conductive elements comprise at least a first antenna conductive element and a second antenna conductive element that is longer than the first antenna conductive element, and
the second antenna conductive element is disposed farther from a shell of the housing than the first antenna conductive element.

3. The antenna unit according to claim 1, wherein the second antenna conductive element is disposed in a center of the housing.

4. The antenna unit according to claim 2, wherein the second antenna conductive element is disposed in a center of the housing.

5. The antenna unit according to claim 1, wherein the second antenna conductive element resonates at a lowest frequency in the plurality of antenna conductive elements.

6. The antenna unit according to claim 2, wherein the second antenna conductive element is longest in the plurality of antenna conductive elements.

7. The antenna unit according to claim 1, wherein the plurality of antenna conductive elements are laminatedly disposed in the housing.

8. The antenna unit according to claim 2, wherein the plurality of antenna conductive elements are laminatedly disposed in the housing.

9. A communication device comprising the antenna unit according to claim 1 mounted thereon.

10. A communication device comprising the antenna unit according to claim 2 mounted thereon.
